(19) United States
(12) Patent Application Publication
(10) Pub. No.: US 2018/0063567 A1
(43) Pub. Date: Mar. 1, 2018

(54) MIMICKING TELEVISION DISPLAYS

(71) Applicant: Hewlett-Packard Development Company, L.P., Houston, TX (US)

(72) Inventor: Robert CAMPBELL, Cupertino, CA (US)

(21) Appl. No.: 15/557,021

(22) PCT Filed: May 15, 2015
(86) PCT No.: PCT/US2015/030962

§ 371 Date: Sep. 8, 2017

(51) Int. Cl. H04N 21/41; H04N 5/60; H04N 21/442; H04N 21/422

(52) U.S. Cl. CPC H04N 21/4131; H04N 21/42202; H04N 21/44204; H04N 5/60

(57) ABSTRACT

One example of a system includes a control device communicatively coupled to a color capable light bulb. The control device stores television show viewing information. The color capable light bulb is controlled by the control device to mimic a television display based on the stored television show viewing information.

### BACKGROUND

An occupied home is less likely to be broken into by an intruder than an unoccupied home. Therefore, to dissuade potential intruders from breaking into an unoccupied home, the home should appear to be occupied even when the home is unoccupied. One way in which a home appears to be occupied from outside of the home is to have a television within the home turned on. When a potential intruder sees a television within the home turned on, the potential intruder is less likely to break into the home since they will assume the home is occupied.

### BRIEF DESCRIPTION OF THE DRAWINGS

FIG. 1 is a block diagram illustrating one example of a system for mimicking a television.

FIG. 2 is a block diagram illustrating another example of a system for mimicking a television.

FIG. 3 is a block diagram illustrating one example of a processing system.

FIG. 4 is a flow diagram illustrating one example of a method for mimicking a television.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

FIG. 1 is a block diagram illustrating one example of a system 100 for mimicking a television. System 100 includes a control device 102 and a color capable light bulb 108. Control device 102 is communicatively coupled to color capable light bulb 108 through a communication path 106. Communication path 106 may be a wired communication path or a wireless communication path (e.g.. WiFi, Bluetooth, ZigBee). Control device 102 stores television (TV) show viewing information 104. Color capable light bulb 108 is controlled by control device 102 to mimic a television display based on stored television show viewing information 104.

By using system 100, an unoccupied home will appear to be occupied by someone watching television without having an actual television turned on. System 100 consumes much less energy than an actual television making the simulated television a more cost effective solution for making a home appear to be occupied than turning on an actual television. In addition, by controlling color capable light bulb 108 based on stored television show viewing information, a more realistic simulation of an actual television show may be achieved.

Control device 102 may be a dedicated standalone device or part of a smart home system used to control lighting, thermostats, security systems, locks, home entertainment systems, and/or other suitable devices within a home. Control device 102 monitors the television show viewing habits of the occupants and stores the television show viewing information. For example, television show viewing information 104 may include the names of televisions shows and the days of the week and the times the television shows were watched. In another example, television show viewing information 104 may include the type of television show (e.g., sports such as football, baseball, basketball, golf, etc.; drama; action; science fiction; etc.) and the days of the week and the times the television shows were watched. In yet another embodiment, television show viewing information 104 may include the channels watched and the days of the week and the times the channels were watched.

Control device 102 includes at least two modes, including a “home” mode, in which control device 102 may control color capable light bulb 108 to provide a desired color and brightness of light and an “away” mode, in which control device 102 may control color capable light bulb 108 to mimic a television display. In other examples, control device 102 may include additional modes for controlling color capable light bulb 108. The different modes of control device 102 may be manually selected by a user or automatically selected based on a previously defined program or rule.

Based on the television show viewing information, control device 102, when switched to a proper mode (e.g., “away”), controls color capable light bulb 108 to mimic a television display. For example, if the day is a Monday and the time is 9PM, control device 102 may control color capable light bulb 108 to mimic the television show that was last watched or most frequency watched at 9PM on a Monday (e.g., football). Control device 102 controls color capable light bulb 108 by sending commands to the light bulb to vary the color, brightness, transitions, and flicker of the light bulb to simulate a television display. The commands may include commands to mimic both a particular television show or type of television show and the commercial breaks within the television show.

Color capable light bulb 108 is any light bulb capable of providing a plurality of colors and brightness levels based on commands received by the bulb from control device 102. Examples of suitable color capable light bulbs 108 include, but are not limited to, Phillips Hue™ bulbs, Flux™ bulbs, Lümen™ bulbs, Samsung™ bulbs, and LG™ bulbs. In one example, color capable light bulb 108 is a multi-color LED, screw terminal light bulb including a wired or wireless interface to receive commands for varying the color, brightness, transitions, and flicker of the light bulb.

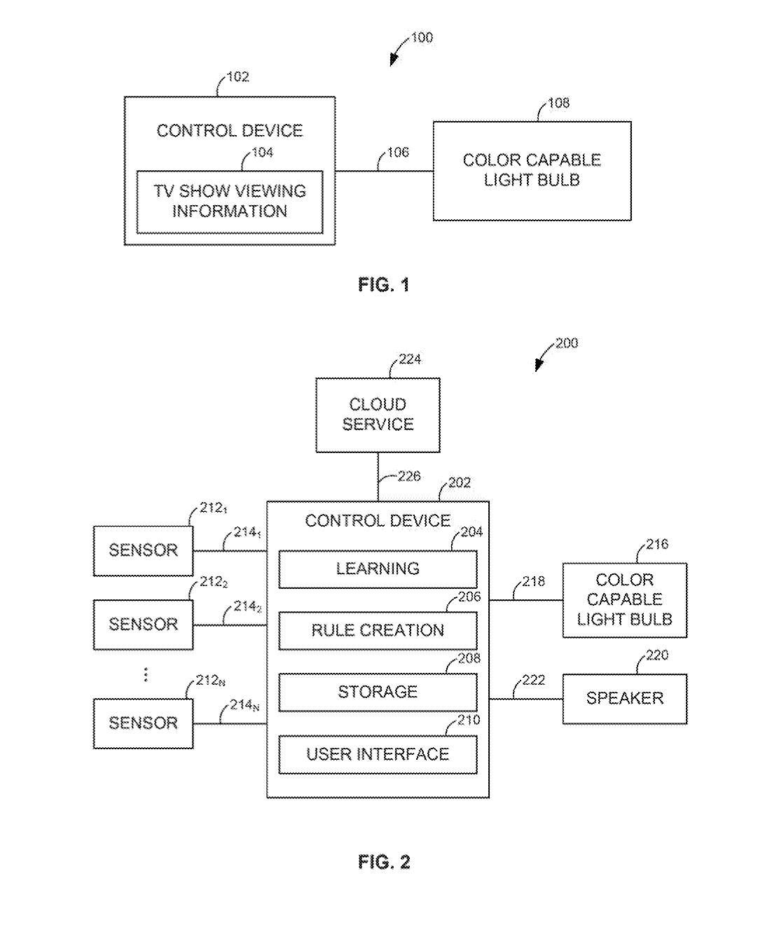

FIG. 2 is a block diagram illustrating another example of a system 200 for mimicking a television. System 200 includes a control device 202, a plurality of sensors 212₁ to 212_{N}, where “N” is any suitable number of sensors, a color capable light bulb 216, a speaker 220, and a cloud service 224. Control device 202 is communicatively coupled to each sensor 212₁ to 212_{N} through a communication path 214₁ to 214_{N}, respectively. Each communication path 214₁ to 214_{N} may be a wired communication path or a wireless communication path (e.g., WiFi, Bluetooth, ZigBee). Control device 202 is communicatively coupled to color capable light bulb 216 through a communication path 218 and to speaker 220 through a communication path 222. Each communication path 218 and 222 may be a wired communication path or a wireless communication path (e.g., WiFi, Bluetooth, ZigBee). Control device 202 is communicatively coupled to cloud service 224 through a communication path 226. Communication path 226 may include one or any combination of a local area network, a wide area network, and the Internet.

Control device 202 includes a learning module 204, a rule creation module 206, a storage module 208, and a user interface 210. Control device 202 receives sensor data from sensors 212₁ to 212_{N}. Sensors 212₁ to 212_{N} may include light sensors, power sensors, switch sensors, sound sensors, and/or other suitable sensors. In one example, learning module 204 uses the sensor data to learn the television viewing habits of the occupants. The television viewing habits may be stored as television show viewing information in storage module 208.

Rule creation module 206 may be used to create rules for controlling color capable light bulb 216 and speaker 220 based on user inputs, day, time, sensor data, and/or other suitable inputs. The rules may be stored in storage module 208. A rule may be activated in response to the various conditions of the rule being satisfied to control color capable light bulb 216 and/or speaker 220 in the manner defined by the rule. For example, a rule may be programmed to control color capable light bulb 216 to mimic a particular television show in response to the current day and time indicating that the particular television show is normally watched during that time.

User interface 210 enables a user to configure sensors, color capable light bulbs, and speakers connected to system 200; create and/or modify rules; place control device 202 into different, modes, such as “home” or “away;” and directly control color capable light bulb 216 and speaker 220. User interface 210 may be implemented via a remote control, a wall mounted control panel, a personal computer, a tablet computer, a smartphone, or another suitable device communicatively coupled to or integrated within control device 202.

Color capable light bulb 216 is any light bulb capable of providing a plurality of colors and brightness levels based on commands received by the bulb from control device 202. Speaker 220 is any device capable of producing sound based on an audio signal received from control device 202 to mimic television sounds. Speaker 220 may be a standalone speaker dedicated to system 200 or part of a home entertainment system communicatively coupled to system 200. In one example, speaker 220 and color capable light bulb 216 are integrated into a single device. Speaker 220 may receive an audio signal of an actual television show or an audio signal that drives speaker 220 to generate simulated or muffled sounds to mimic a television show.

Cloud service 224 may transmit live television show information to control device 202 to control color capable light bulb 216. In this way, color capable light bulb 216 is controlled by control device 202 to mimic a live television show. The live television show to be mimicked may be selected based on the television show viewing information stored in storage module 208. For example, if the day is a Wednesday and the time is 6PM, control device 202 may control color capable light bulb 216 to mimic the type of show that was last watched or most frequency watched at 6PM on a Wednesday (e.g., live news). In one example, cloud service 224 provides the commands to control device 202, which control device 202 forwards to color capable light bulb 216 to control color capable light bulb 216. In another example, control device 202 selects or generates the commands to send to color capable light bulb 216 based on the live television show information received from cloud service 224, such as live television show names or types.

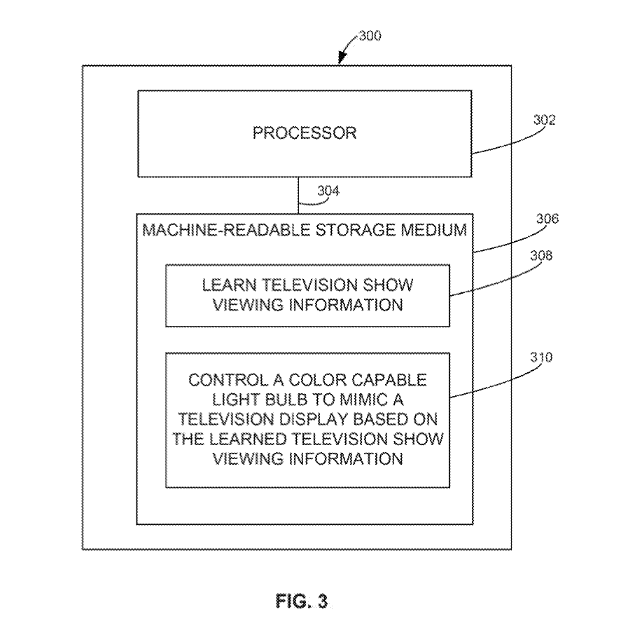

FIG. 3 is a block diagram illustrating one example of a processing system 300. System 300 may include at least one computing device and may provide control device 102 or control device 202 previously described and illustrated with reference to FIGS. 1 and 2, respectively. System 300 includes a processor 302 and a machine-readable storage medium 306. Processor 302 is communicatively coupled to machine-readable storage medium 306 through a communication path 304. Although the following description refers to a single processor and a single machine-readable storage medium, the description may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 302 includes one or more Central Processing Units (CPUs), microprocessors, and/or other suitable hardware devices for retrieval and execution of instructions stored in machine-readable storage medium 306. Processor 302 may fetch, decode, and execute instructions 308 to learn television show viewing information and instructions 310 to control a color capable light bulb to mimic a television display based on the learned television show viewing information. As an alternative or in addition to retrieving and executing instructions, processor 302 may include one or more electronic circuits comprising a number of electronic components for performing the functionality of one or more of the instructions in machine-readable storage medium 306. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

Machine-readable storage medium 306 is a non-transitory storage medium and may be any suitable electronic, magnetic, optical, or other physical storage device that stores executable instructions. Thus, machine-readable storage medium 306 may be, for example, Random Access Memory (RAM), an Electrically-Erasable Programmable Read-Only Memory (EEPROM), a storage drive, an optical disc, and the like. Machine-readable storage medium 306 may be disposed within system 300, as illustrated in FIG. 3. In this case, the executable instructions may be installed on system 300. Alternatively, machine-readable storage medium 306 may be a portable, external, or remote storage medium that allows system 300 to download the instructions from the portable/external/remote storage medium. In this case, the executable instructions may be pail of an installation package.

Machine-readable storage medium 306 stores instructions to be executed by a processor (e.g., processor 302) including instructions 308 and 310 to operate system 100 or 200 as previously described with reference to FIGS. 1 and 2, respectively. Processor 302 may execute instructions 308 to learn television show viewing information as previously described with reference to FIGS. 1 and 2. In one example, learning the television show viewing information includes learning the names of television shows and the days of the week and the times the television shows were watched. Processor 302 may execute instructions 310 to control a color capable light bulb to mimic a television display based on the learned television show viewing information as previously described with reference to FIGS. 1 and 2.

In one example, processor 302 may also execute instructions to control a speaker (e.g., speaker 220 previously described and illustrated with reference to FIG. 2) to mimic a television sound based on the stored television show viewing information. In another example, processor 302 may execute instructions to receive live television show information (e.g., via cloud service 224 previously described and illustrated with reference to FIG. 2) and to control the color capable light bulb based on the received live television show information. In yet another example, processor 302 may execute instructions to collect information from a plurality of sensors (e.g., sensors 212₁ to 212_{N} previously described and illustrated with reference to FIG. 2) to learn the television show viewing information. In yet another example, processor 302 may execute instructions to wirelessly control the color capable light bulb.

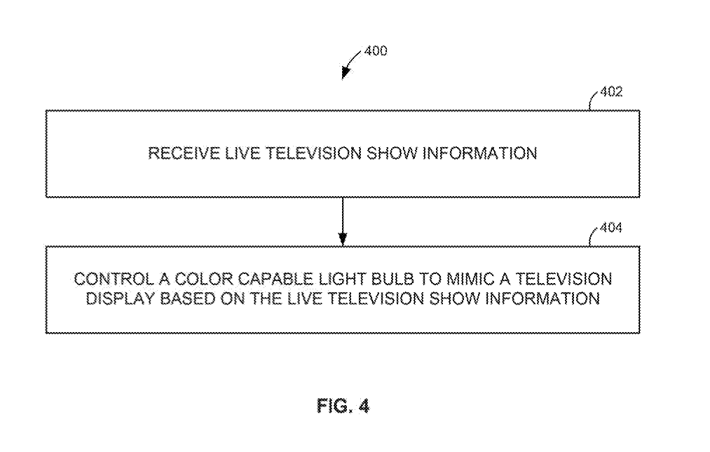

FIG. 4 is a flow diagram illustrating one example of a method 400 for mimicking a television. At 402, live television show information is received. In one example, the live television show information includes live television show names. At 404, a color capable light bulb is controlled to mimic a television display based on the live television show information. In one example, method 400 also includes controlling a speaker to mimic a television sound based on the live television show information. In another example, method 400 includes learning television show viewing information by collecting sensor data and controlling the color capable light bulb based on the learned television show viewing information. In yet another example, method 400 includes storing television show viewing information and controlling the color capable light bulb based on the stored television show viewing information. In yet another example, method 400 includes wirelessly controlling the color capable light bulb.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a control device to store television show viewing information; and
a color capable light bulb communicatively coupled to the control device, the color capable light bulb controlled by the control device to mimic a television display based on the stored television show viewing information.

2. The system of claim 1, further comprising:
a speaker communicatively coupled to the control device, the speaker controlled by the control device to mimic television sounds based on the stored television show viewing information.

3. The system of claim 1, further comprising:
a cloud service communicatively coupled to the control device, the cloud service to transmit live television show information to the control device to control the color capable light bulb.

4. The system of claim 1, further comprising:
a plurality of sensors communicatively coupled to the control device to collect data to learn the television show viewing information.

5. The system of claim 1, wherein the control device wirelessly controls the color capable light bulb.

6. A machine-readable storage medium encoded with instructions, the instructions executable by a processor of a system to cause the system to:
learn television show viewing information including names of television shows and days of the week and times the television shows were watched; and
control a color capable light bulb to mimic a television display based on the learned television show viewing information.

7. The machine-readable storage medium of claim 6, wherein the instructions are executable by the processor to further cause the system to:
control a speaker to mimic a television sound based on the learned television show viewing information.

8. The machine-readable storage medium of claim 6, wherein the instructions are executable by the processor to further cause the system to:
receive live television show information; and
control the color capable light bulb based on the received live television show information.

9. The machine-readable storage medium of claim 6, wherein the instructions are executable by the processor to further cause the system to:
collect information from a plurality of sensors to learn the television show viewing information.

10. The machine-readable storage medium of claim 6, wherein the instructions are executable by the processor to further cause the system to:
wirelessly control the color capable light bulb.

11. A method comprising:
receiving live television show information including live television show names; and
controlling a color capable light bulb based on the live television show information.

12. The method of claim 11, further comprising:
controlling a speaker to mimic a television sound based on the television show information.

13. The method of claim 11, further comprising:
learning television show viewing information by collecting sensor data, and
controlling the color capable light bulb based on the learned television show viewing information.

14. The method of claim 11 further comprising:
storing television show viewing information; and
controlling the color capable light bulb to mimic a television display based on the stored television show viewing information.

15. The method of claim 11, wherein controlling the color capable light bulb comprises wirelessly controlling the color capable light bulb.
